(19) United States
(12) Patent Application Publication
(10) Pub. No.: US 2023/0237563 A1
(43) Pub. Date: Jul. 27, 2023

(54) COMPUTER-BASED METHOD ALLOWING USER TRANSACTIONS IN AN AUGMENTED SPACE

(71) Applicant: JUDA UNIVERSE SDN. BHD., Kajang (MY)

(72) Inventors: Fu Seng LOO, Kajang (MY); Fook Wah CHEN, Kajang (MY)

(73) Assignee: JUDA UNIVERSE SDN. BHD., Kajang (MY)

(21) Appl. No.: 17/907,926

(22) PCT Filed: Aug. 22, 2020
(86) PCT No.: PCT/MY2020/050072

§ 371 Date: Aug. 29, 2022

(51) Int. Cl. G06Q 30/0601; G06Q 10/0836

(52) U.S. Cl. CPC G06Q 30/0643; G06Q 10/0836; G06Q 30/0623

(57) ABSTRACT

A computer-based method that allows users to conduct transactions and interact with environments and objects in an augmented space using any generic electronic device with a display and user input. The environment can be virtually rendered or 360° image or video pre-captured and allows the user to move around within it. Products, information, navigational or communication hotspots can be accessed by the user via the electronic device. Objects such as products are displayed as a 360° image and is user-interactable. There is an option for a physical kiosk located within a retail space that allows for offline (non Internet) use.

### TECHNICAL FIELD

The present invention relates to a computer-based method allowing transactions to users in an augmented space, and specifically to one that allows unique user interactions in that augmented space.

### BACKGROUND ART

Computer-based online systems providing transaction services such as shopping are very commonplace nowadays. The advantages of going online to conduct transactions such as shopping for a product or service are clear. There is no need for the merchant to maintain a physical store, along with the associated costs and other issues such as customer safety and comfort, mechanical and electrical engineering limitations, floor space and design limitations, etc. Having a virtual store in a virtual or augmented space allows store dimensions and design aesthetics that may be cost-prohibitive or simply impossible in the real world, low running costs, and being unhampered by mechanical and electrical engineering limitations.

Current online shopping systems are mainly of two types. The first is known as e-commerce platforms, and include platforms such as Amazon and Alibaba. These platforms tend to display only catalogue listings with only basic information on products and services, along with static images. They typically do not allow for user interaction with the product. There is also no user immersion into a shopping experience such as moving around a retail area or browsing items in a store environment.

The second type of online shopping system uses 3D virtual reality to create a very immersive experience for the user. One problem with this type of system is that they require specialized equipment such as VR headsets and motion controllers, along with proprietary software. Furthermore, VR technology is still a developing technology, and comes with several drawbacks such as unnatural feeling interactions that may cause headaches or nausea to some users. The virtual 3D worlds are also very costly to generate; the data bandwidth required is considerable and powerful 3D rendering hardware needed in order to deliver high resolution images.

What is needed in the art is an online system that allows transactions such as shopping and other services that overcomes the above issues by striking a balance between e-commerce platforms and VR systems by addressing the lack of immersion in the e-commerce platforms, and at the same time reducing or eliminating altogether the above-mentioned deficiencies of a full blown VR system.

### SUMMARY OF INVENTION

The present invention seeks to overcome the aforementioned disadvantages by providing a computer-based method that allows users to conduct transactions and interact with environments and objects in an augmented space using any generic electronic device with a display and user input. The environment can be virtually rendered or 360° image or video pre-captured and allows the user to move around within it. Products, information, navigational or communication hotspots within the environment can be accessed by the user via the electronic device. Objects such as products are displayed as a 360° image and is user-interactable, meaning the user is able to perform various actions on the image that lead to a modified or new image being uploaded. There is an option for a physical kiosk located within a retail space that allows for offline (non Internet) use.

The present invention thus relates to a computer-based method allowing a retail experience on an electronic device, comprising the steps of:
displaying at least one virtual location on the electronic device;
receiving a selection of the virtual location from a user of the electronic device;
displaying at least one storefront on the electronic device, each storefront associated with a store contained within the selected virtual location;
receiving a selection of storefront from the user;
displaying either a static 360° viewable image or a moving 360° viewable video of the selected storefront on the electronic device;
displaying a user-interactable environment of the selected storefront on the electronic device having a user-selectable link to individual products or services;
receiving a selection of said product or service from the user;
displaying details including an image or video of the user-selected product or service on the electronic device, including user-selectable links to: load a 360° viewable and interactable image or video of the product or service, and to purchase the product or service, whereby the interactable image includes the user performing various actions on the image that lead to a modified or new image being displayed;
receiving a selection of whether to load a 360° viewable and interactable image or video of the product or service, or to purchase the product or service from the user;
if user selects to load a 360° viewable and interactable image or video of the product or service, displaying the 360° viewable image or video of the product or service on the electronic device, including a user-selectable link to purchase the product or service; and
if user selects to purchase the product or service, displaying a method of payment to allow the user to pay for the product or service.

In a preferred embodiment, the virtual location is any of: shopping malls, shopping streets, education establishments, real-estate property, hospitals, tourism centers, food centers.

In another preferred embodiment, the stores are any of: a retail store, school, university or other education establishments, real-estate property demo unit, departments within a hospital, tourism store, restaurants or other food stores.

In yet another preferred embodiment, the user-interactable environment of the selected storefront comprises a link to navigate to a substore location located within the store. If this link to navigate to a substore location is selected by the user, the electronic device displays a static 360° viewable image or a moving 360° viewable video of the selected substore location.

In yet another preferred embodiment, the user-interactable environment of the selected storefront comprises a link to information about the store. If this link to information about the store is selected by the user, the electronic device displays relevant information about the store.

In yet another preferred embodiment, the user-interactable environment of the selected storefront comprises a link to communication with the store. If this link to communication with the store is selected by the user, one of the following connections is established between the user and a representative of the store: video call, voice call and text messaging.

In one preferred embodiment of the present invention, the electronic device is any computer-based device with a display and user input means such as a touchscreen, mouse, keyboard, or combination thereof that is connected to the Internet where it is able to access a server or servers and databases required for the method of this invention to be executed properly.

In another preferred embodiment, the electronic device is a physical kiosk located in a retail space, the kiosk having a display and user input means such as a touchscreen, mouse, keyboard, or combination thereof. This kiosk can be connected to the Internet, but it can also operate without connection to the Internet, in which case it is connected wired or wirelessly to a local network that contains a server or servers and databases required for the method of this invention to be executed properly. After purchasing a product or service from the kiosk, the user is then able to retrieve the product or service from the store at the time of purchase via a locker system whereby the purchased product or service is stored in a locked locker within or near to the store’s premises, and the unlock code for said locker is given to said user upon payment for the product or service

Other objects and advantages will be more fully apparent from the following disclosure and appended claims.

### TECHNICAL PROBLEM

Online shopping platforms do not provide an immersive shopping experience to the user. Full blown VR shopping require specialized and costly equipment, high Internet bandwidth, and can feel unnatural.

### SOLUTION TO PROBLEM

Strike a balance between a regular online shopping platform and full blown VR shopping by providing a computer-based method that allows users to conduct transactions and interact with environments and objects in an augmented space using any generic electronic device with a display and user input. The environment can be virtually rendered or 360° image or video pre-captured and allows the user to move around within it. Products, information, navigational or communication hotspots within the environment can be accessed by the user via the electronic device. Objects such as products are displayed as a 360° image and is user-interactable, meaning the user is able to perform various actions on the image that lead to a modified or new image being uploaded. There is an option for a physical kiosk located within a retail space that allows for offline (non Internet) use.

### BRIEF DESCRIPTION OF DRAWINGS

FIG. 1 shows a process flow of remotely purchasing from an online store in an embodiment of this invention.

FIG. 2 shows a process flow of purchasing from a kiosk in an embodiment of this invention.

FIG. 3 shows a network architecture diagram of remotely purchasing from an online store in an embodiment of this invention.

FIG. 4 shows a network architecture diagram of purchasing from a kiosk in an embodiment of this invention.

### DESCRIPTION OF EMBODIMENTS

It should be noted that the following detailed description is directed to a computer-based method allowing transactions to users in an augmented space, and is not limited to any particular size or configuration but in fact a multitude of sizes and configurations within the general scope of the following description. The term “product” refers to both products and services. The terms “device” and “electronic device” are interchangeable and mean the same thing.

### Remote Connection

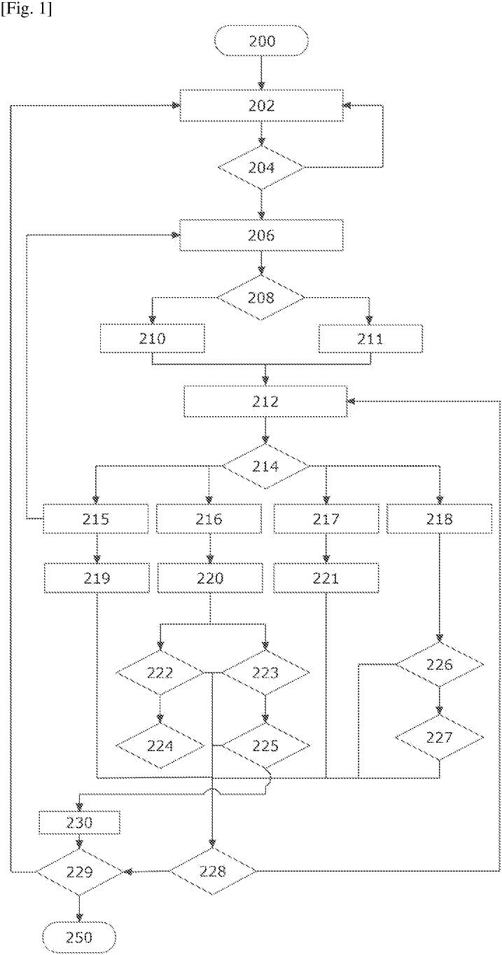

Referring to FIG. 1, there is shown a process flow diagram for providing a realistic experience to a user on a remote computer-based electronic device having a display and user input such as touchscreen, keyboard, mouse or combination thereof, and allowing the user to perform transactions via said device for the purposes of purchasing one or more products or services. The electronic device is connected to a network of servers and databases that work together to provide said experience to the user.

After the process is initiated at the start of the session (200), at least one available virtual location (usually there are several) is displayed (202) on said display. The virtual location can be any of: shopping malls, shopping streets, education establishments, real-estate property, hospitals, tourism centers, food centers. The virtual location is essentially recreating a real-world location that a person would go to in search of conducting shopping, learning, medical and hospitality transactions. The user then selects one of said virtual locations (204). At least one storefront (usually there are several) associated to the selected virtual location is then loaded to said electronic device and displayed on said display (206). The user then selects one of said storefronts (208). The user chooses to view either a static 360° viewable image (210) or a moving 360° viewable video (211) of said selected storefront on said electronic device, and the user’s choice is then displayed on said display. Each storefront is associated with a store contained within said selected virtual location. Each said store is any of: a retail store, school, university or other education establishments, real-estate property demo unit, departments within a hospital, tourism store, restaurants or other food stores. A user-interactable environment of said selected storefront is then loaded and displayed (212) on said electronic device. This said user-interactable environment is provided with user-selectable links to one or more hotspots (214), including: navigation hotspot, product hotspot, information hotspot and communication hotspot.

In the navigation hotspot (215), the user may choose to either: return to the main storefront, in which case they are taken back to 206 above, or navigate to one or more substores located within said selected storefront, in which case the electronic device displays a static 360° viewable image or a moving 360° viewable video of the selected substore location.

In the product hotspot (216) at least one (usually there are several) products are shown, each product represented by an user-selectable image. If the user selects one of the products by clicking on said image, more extensive details of the product is displayed on the display (220), along with options for either viewing (222) a 3D representation of the product or purchasing (223) the product. If the user chooses to view (222) a 3D representation of the product, a 3D 360° interactable representation of the product either as an image of video is displayed (224) on the display. The user is able to interact with the representation by any of: moving it around, rotating, panning, and zooming. The user can also perform certain actions on the representation such as interacting with certain parts of the representation which results in changes to the representation of the product. As an example, the user may click or tap on the open / close button of a microwave oven, which then causes the representation to change to an image of a microwave oven with an open door, or vice versa. The user can also cause the production of sensory stimulus to the user, such as sight, sound, smell, taste and touch, by interacting with predetermined portions of the image. As an example, the user may click or tap on a bag of chips and a soundclip of a crunchy chip being bitten into is played back on the device. Or the user may click or tap on the ignition of a car being viewed and a soundclip of the actual engine starting is played back on the device. Or the user may be viewing a music player with an LCD screen, and clicking or tapping on the screen shows a representation of the music player with its LCD screen in action.

If the user opts (223) to purchase the product, the selected product is placed (225) in a shopping cart. To pay for the product, the user selects to checkout (230), where the user selects the type of payment, which can be any of: online banking, e-wallet, credit card and QR pay. Once payment is complete, the order is created, shipping cost and provider information is displayed on the device and sent to the store. If the user does not choose to navigate back to another virtual location, the session ends (250)

In the information hotspot (217), the display is provided with user-selectable links to information about said store. If this link to information about the store is selected by the user, the electronic device displays (221) relevant information about the store.

In the communication hotspot (218), the display is provided with a link to communication with the store. If this link to communication with the store is selected (226) by the user, one of the following connections is established (227) between the user and a representative of the store: video call, voice call and text messaging.

Still referring to FIG. 1, once the user has viewed the substore location, 3D product or communicated with the store, they may then select (228) to navigate to another hotspot location or product within said selected storefront. If the user selects to navigate to another hotspot location or product within said selected storefront, the display goes back to 212 and displays the user-interactable environment of said selected storefront on said electronic device. If the user does not wish to return to the same storefront, they may select (229) to return to another virtual location, in which case, the display goes back to 202 and displays available virtual locations. If the user does not select to return to another virtual location, the session ends (250)

### On-Site Access (Physical Kiosk)

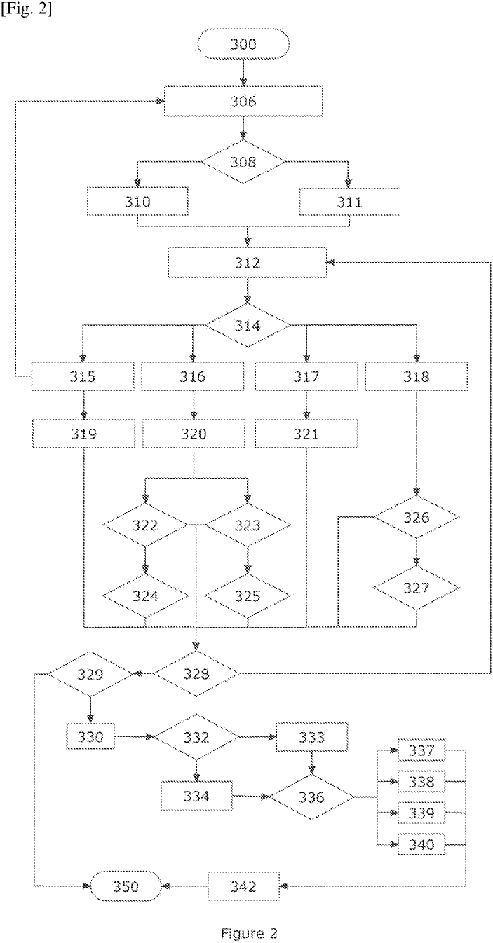

Referring now to FIG. 2, there is shown a process flow diagram for providing a realistic experience to a user on an on-site computer-based electronic device such as a kiosk, having a display and user input such as touchscreen, keyboard, mouse or combination thereof, and allowing the user to perform transactions via said device for the purposes of purchasing one or more products or services. The device is located in a public space such as a shopping mall, shopping street, education establishment, real-estate property, hospital, tourism center, or food center. The device connected may be connected to the Internet, but it can operate offline with only direct wired or wireless to a local network of servers and databases located within the premises where it is located.

After the process is initiated at the start of the session (300), at least one available storefront (usually there are several) located within the premises is then loaded to said device and displayed on said display (306). The user then selects one of said storefronts (308). The user chooses to view either a static 360° viewable image (310) or a moving 360° viewable video (311) of said selected storefront on said device, and the user’s choice is then displayed on said display. Each storefront is associated with a store contained within said premises. Each said store is any of: a retail store, school, university or other education establishments, real-estate property demo unit, departments within a hospital, tourism store, restaurants or other food stores. A user-interactable environment of said selected storefront is then loaded and displayed (312) on said device. This said user-interactable environment is provided with user-selectable links to one or more hotspots (314), including: navigation hotspot, product hotspot, information hotspot and communication hotspot.

In the navigation hotspot (315), the user may choose to either: return to the main storefront, in which case they are taken back to 306 above, or navigate to one or more substores located within said selected storefront, in which case the device displays a static 360° viewable image or a moving 360° viewable video of the selected substore location.

In the product hotspot (316) at least one (usually there are several) products are shown, each product represented by an user-selectable image. If the user selects one of the products by clicking on said image, more extensive details of the product is displayed on the display (320), along with options for either viewing (322) a 3D representation of the product or purchasing (323) the product. If the user chooses to view (322) a 3D representation of the product, a 3D 360° interactable representation of the product either as an image of video is displayed (324) on the display. The user is able to interact with the representation by any of: moving it around, rotating, panning, and zooming. The user can also perform certain actions on the representation such as interacting with certain parts of the representation which results in changes to the representation of the product. As an example, the user may click or tap on the open / close button of a microwave oven, which then causes the representation to change to an image of a microwave oven with an open door, or vice versa. The user can also cause the production of sensory stimulus to the user, such as sight, sound, smell, taste and touch, by interacting with predetermined portions of the image. As an example, the user may click or tap on a bottle of perfume, and a small amount of that perfume is sprayed from the kiosk. If the user opts (323) to purchase the product, the selected product is placed (325) in a shopping cart.

After that, the user may select (328) if they wish to navigate to another hotspot location or product within said selected storefront. If the user selects to navigate to another hotspot location or product within said selected storefront, the display goes back to 312 and displays the user-interactable environment of said selected storefront on said device. If the user does not wish to navigate to another hotspot location or product within said selected storefront, they are asked (329) to select to either checkout or end the session. If the user selects to checkout, the in-store checkout procedure is displayed (330) on the device. The product is checked (332) for availability to collect in-store. If the product is available for collection in-store, a locker code is generated (333). The locker code is a code to unlock a locker containing the product and located within the premises. After the transaction is complete, the user may unlock the locker using this code and retrieve the product. If the product is not available for collection in-store, shipping cost and provider information is displayed (334) on the device. To pay for the product, the user selects (336) the type of payment, which can be any of: online banking (337), e-wallet (338), credit card (339) and QR pay (340). Once payment is complete, the order is created and sent to the store (342), and the session ends (350)

In the information hotspot (317), the display is provided with user-selectable links to information about said store. If this link to information about the store is selected by the user, the electronic device displays (321) relevant information about the store.

In the communication hotspot (318), the display is provided with a link to communication with the store. If this link to communication with the store is selected (326) by the user, one of the following connections is established (327) between the user and a representative of the store: video call, voice call and text messaging.

### Network Architecture

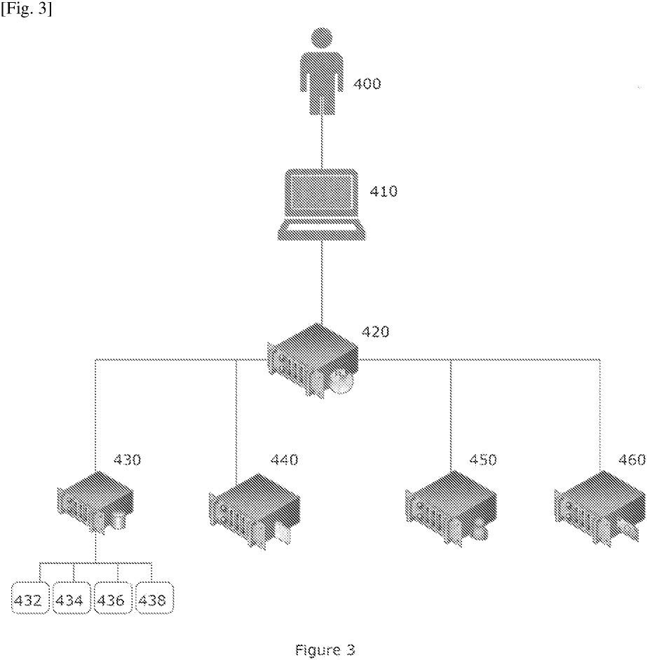

Referring now to FIG. 3, there is shown an illustration of the network architecture of this invention as it applies to a user using an electronic device that is remotely connected via the Internet, such as in the process described in FIG. 1 above. When a session is started by the user (400) on an electronic device (410), a web server (420) requests a database server (430) for available virtual locations. The database server (430) accesses a location database (432) for available locations and associated metadata and sends this information back to the web server (420). The web server (420) then accesses a file server (440) and retrieves media such as images and videos stored on the file server that are associated with the said available locations. The said retrieved media, along with the other retrieved information is then sent to the device (410) and shown on a display of said device. The user sees on the device a representation of the virtual location, and the user is able to interact with the virtual location, including moving around in it by tapping or clicking on various portions of the screen.

The user (400) then selects one of the available locations using a user input means such as a touch screen, mouse or keyboard located on the device (410). Based on said selected location, the web server (420) accesses a storefront database (434) located on said database server (430), and retrieves available storefronts associated with said selected location, along with associated metadata from said storefront database. The web server (420) also accesses said file server (440) and retrieves media such as images and videos stored on the file server that are associated with the said available storefronts. The said retrieved media, along with the other retrieved information is then sent to the device (410) and shown on a display of said device. The user now sees on the device a representation of the storefront, and the user is able to interact with items in the storefront, including moving around in it by tapping or clicking on various portions of the screen. There is at least one main store and optionally at least one substore location that the user can navigate to. The substore location can be different areas of the main store that was not loaded onto the device together with the main store. If the user taps or clicks on a portion of the storefront linked to a substore location, the web server (420) then retrieves images or videos of the selected substore location and sends it to the device (410) to be displayed to the user. The said displayed storefronts also contain links allowing the user (400) to select either to view a static 360° viewable image or a moving 360° viewable video of each storefront.

The user (400) then selects a storefront, and either said static image or moving video. From this, the web server (420) accesses said storefront database (434) and retrieves more detailed information specific to the said selected storefront, such as yaw, pitch and field of view of the storefront, as well as merchant details and store information. The web server (420) also accesses the said file server (440) and retrieves media corresponding to the said selection of either static image or moving video specific to the selected storefront. This retrieved media, along with the other retrieved information is then sent to the device (410) and shown on a display of said device. Also shown on the device (410) at this point are links to four hotspots: Navigation hotspot, product hotspot, information hotspot and communication hotspot, all of which are retrieved from the database server (430) by the web server (420).

If the user selects the navigation hotspot, the web server (420) accesses the storefront database (434) and retrieves available navigable locations such as other available storefronts.

If the user selects a product from the product hotspot, the web server (420) accesses a product database (436) located on the database server (430), and retrieves information as well as short media clips associated with said selected product, from said product database (436) to send back to the device (410). This includes 3D or 360° viewable and interactable image or video of said selected product. The user is able to interact with said representations of the selected product on the device (410). This includes tapping or clicking on certain parts of the representation to elicit either changes in the representation, or certain sounds to be played. The user (400) may also select to purchase the product by placing it in a shopping cart, in which case the web server (420) saves the product being in the shopping cart on the database server (430). The user may access the shopping cart later for completing payment. Alternatively, the user may continue shopping by navigating to other storefronts via the navigation hotspot.

If the user selects to make payment, the web server (420) accesses a secure payment server (460) which enables various payment methods such as: credit / debit card, e-wallet, online banking and QR pay. The web server (420) also makes shipping arrangements to deliver the product to a location of the user’s choosing.

If the user selects to view information in said information hotspot, the web server (420) accesses either an information database (438) for information about the store, or said product database (436) for information about a particular product.

If the user selects to communicate with the merchant in said communication hotspot, the web server (420) accesses a communication server (450), which is able to establish either a video call, voice call, or text messaging communication link between the device (410) and a representative of the merchant.

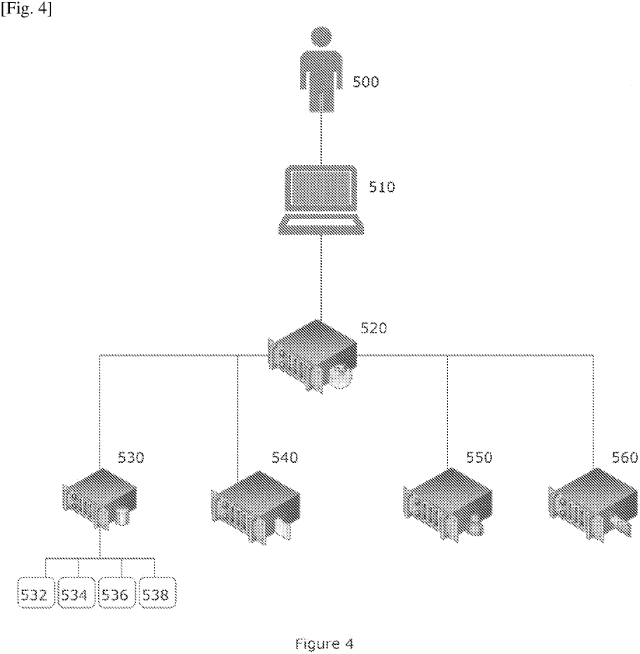

Referring now to FIG. 4, there is shown an illustration of the network architecture of this invention as it applies to a user using a physical kiosk (510) located within or near a retail store area, in an embodiment of this invention such as in the process described in FIG. 2 above. The kiosk does not need to be connected to the Internet to perform as intended, as it can connect to and utilize a local area network comprising the necessary servers and databases described herein. When a session is started by the user (500) on said kiosk (510), a terminal server (520) accesses a storefront database (534) located on a database server (530), and retrieves available storefronts located in the retail premises, along with associated metadata from said storefront database. The terminal server (520) also accesses a file server (540) and retrieves media such as images and videos stored on the file server (540) that are associated with the said available storefronts. The said retrieved media, along with the other retrieved information is then sent to the kiosk (510) and shown on a display on said kiosk. The user now sees on the kiosk (510) a representation of the storefront, and the user is able to interact with items in the storefront, including moving around in it by tapping or clicking on various portions of the screen. There is at least one main store and optionally at least one substore location that the user can navigate to. The substore location can be different areas of the main store that was not loaded onto the device together with the main store. If the user taps or clicks on a portion of the storefront linked to a substore location, the terminal server (520) then retrieves images or videos of the selected substore location and sends it to the kiosk (510) to be displayed to the user. The said displayed storefronts also contain links allowing the user (500) to select either to view a static 360° viewable image or a moving 360° viewable video of each storefront.

The user (500) then selects a storefront, and either said static image or moving video. From this, the terminal server (520) accesses said storefront database (534) and retrieves more detailed information specific to the said selected storefront, such as yaw, pitch and field of view of the storefront, as well as merchant details and store information. The terminal server (520) also accesses the said file server (540) and retrieves media corresponding to the said selection of either static image or moving video specific to the selected storefront. This retrieved media, along with the other retrieved information is then sent to the kiosk (510) and shown on a display of said kiosk. Also shown on the kiosk (510) at this point are links to four hotspots: Navigation hotspot, product hotspot, information hotspot and communication hotspot, all of which are retrieved from the database server (530) by the terminal server (520).

If the user selects the navigation hotspot, the terminal server (520) accesses the storefront database (534) and retrieves available navigable locations such as other available storefronts.

If the user selects a product from the product hotspot, the terminal server (520) accesses a product database (536) located on the database server (530), and retrieves information as well as short media clips associated with said selected product, from said product database (536) to send back to the kiosk (510). This includes 3D or 360° viewable and interactable image or video of said selected product. The user is able to interact with said representations of the selected product on the kiosk (510). This includes tapping or clicking on certain parts of the representation to elicit either changes in the representation, or certain sounds to be played. The user (500) may also select to purchase the product by placing it in a shopping cart, in which case the terminal server (520) saves the product being in the shopping cart on the database server (530). The user may access the shopping cart later for completing payment. Alternatively, the user may continue shopping by navigating to other storefronts via the navigation hotspot.

If the user selects to make payment, the terminal server (520) accesses a secure payment server (560) which enables various payment methods such as: credit / debit card, e-wallet, online banking and QR pay. The terminal server (520) also checks if the product is available in the store. If it is, and payment has been made, the terminal server (520) generates a unique locker code which can be used by the user to open a locker located within or near the retail premises and containing the purchased product. If the product is not available in the store, shipping arrangements are made to deliver the product to a location of the user’s choosing.

If the user selects to view information in said information hotspot, the terminal server (520) accesses either an information database (538) for information about the store, or said product database (536) for information about a particular product.

If the user selects to communicate with the merchant in said communication hotspot, the terminal server (520) accesses a communication server (550), which is able to establish either a video call, voice call, or text messaging communication link between the kiosk (510) and a representative of the merchant.

While several particularly preferred embodiments of the present invention have been described and illustrated, it should now be apparent to those skilled in the art that various changes and modifications can be made without departing from the scope of the invention. Accordingly, the following claims are intended to embrace such changes, modifications, and areas of application that are within the scope of this invention.

### REFERENCE SIGNS LIST

Start of user interaction (200)
Display available virtual location(s) (202)
User selects a virtual location (204)
Display available storefront(s) (206)
User selects a storefront (208)
User selects a static 360° viewable image of storefront (210)
User selects a moving 360° viewable video of storefront (211)
Display storefront environment (212)
Available hotspots (214)
User selects navigation hotspot (215)
User selects product hotspot (216)
User selects information hotspot (217)
User selects communication hotspot (218)
Display a substore location (219)
Display a product (220)
Display store information (221)
User selects to view product (222)
User selects to purchase product (223)
Display 360° image or video of product (224)
Product placed in shopping cart (225)
User selects to communicate with merchant (226)
Establish communication between user and merchant (227)
User selects another hotspot within storefront (228)
User selects another virtual location (229)
Checkout procedure (230)
End (250)
Start of user interaction (300)
Display available storefront(s) (306)
User selects a storefront (308)
User selects a static 360° viewable image of storefront (310)
User selects a moving 360° viewable video of storefront (311)
Display storefront environment (312)
Available hotspots (314)
User selects navigation hotspot (315)
User selects product hotspot (316)
User selects information hotspot (317)
User selects communication hotspot (318)
Display a substore location (319)
Display a product (320)
Display store information (321)
User selects to view product (322)
User selects to purchase product (323)
Display 360° image or video of product (324)
Product placed in shopping cart (325)
User selects to communicate with merchant (326)
Establish communication between user and merchant (327)
User selects another hotspot within storefront (328)
User checks out (329)
Checkout procedure (330)
Check if product is available in store (332)
Generate locker code (333)
Calculate shipping and select provider (334)
Payment page (336)
Online banking (337)
E-wallet (338)
Credit card (339)
QR pay (340)
Create order (342)
End (350)
User (400)
Electronic device (410)
Web server (420)
Database server (430)
Location database (432)
Storefront database (434)
Product database (436)
Information database (438)
File server (440)
Communication server (450)
Payment server (460)
User (500)
Kiosk (510)
Terminal sever (520)
Database server (530)
Location database (532)
Storefront database (534)
Product database (536)
Information database (538)
File server (540)
Communication server (550)
Payment server (560)

1. A computer-based method allowing transactions in an augmented space on an electronic device (410), comprising:
a. displaying (202) at least one virtual location on said electronic device (410);
b. receiving (204) a selection of said virtual location from a user (400) of said electronic device (410);
c. displaying (206) at least one storefront on said electronic device (410), each said storefront associated with a store contained within said selected virtual location;
d. receiving (208) a selection of said storefront from said user;
e. displaying either a static 360° viewable image (210) or a moving 360° viewable video (211) of said selected storefront on said electronic device (410);
f. displaying (212) a user-interactable environment of said selected storefront on said electronic device (410) having a user-selectable link to individual products or services;
g. receiving (216) a selection of said product or service from said user;
h. displaying (220) details including an image or video of said user-selected product or service on said electronic device (410), including user-selectable links to: load a 360° viewable and interactable image or video of said product or service, and to purchase said product or service;
i. receiving a selection of whether to load a 360° viewable and interactable image or video of said product or service (222), or to purchase said product or service (223) from the said user;
j. if user selects to load a 360° viewable and interactable image or video of said product or service, displaying said 360° viewable image or video of said product or service (224) on said electronic device (410), including a user-selectable link to purchase said product or service; and
k. if user selects to purchase said product or service, displaying a method of payment (230) to allow said user to pay for the said product or service.

2. A computer-based method allowing transactions in an augmented space on an electronic device according to claim 1, wherein the said virtual location is any of: shopping malls, shopping streets, education establishments, real-estate property, hospitals, tourism centers, food centers.

3. A computer-based method allowing transactions in an augmented space on an electronic device according to claim 1, wherein the said stores is any of: a retail store, school, university or other education establishments, real-estate property demo unit, departments within a hospital, tourism store, restaurants or other food stores.

4. A computer-based method allowing transactions in an augmented space on an electronic device according to claim 1, wherein said user-interactable environment of said selected storefront further comprises a link to navigate to a substore location located within said store.

5. A computer-based method allowing transactions in an augmented space on an electronic device according to claim 4, wherein if said link to navigate to a substore location is selected (215) by said user, displays (219) on the said electronic device a static 360° viewable image or a moving 360° viewable video of said selected substore location.

6. A computer-based method allowing transactions in an augmented space on an electronic device according to claim 1, wherein said user-interactable environment of said selected storefront further comprises a link to information about said store or products.

7. A computer-based method allowing transactions in an augmented space on an electronic device according to claim 6, wherein if said link to information about said store is selected (217) by said user, displays (221) on the said electronic device relevant information about said store or products.

8. A computer-based method allowing transactions in an augmented space on an electronic device according to claim 1, wherein said user-interactable environment of said selected storefront further comprises a link to communication with the store.

9. A computer-based method allowing transactions in an augmented space on an electronic device according to claim 8, wherein if said link to communication with the store is selected (218) by said user, establishes any of the following connections (226) between said user and a representative of the store: video call, voice call and text messaging.

10. A computer-based method allowing transactions in an augmented space on an electronic device according to claim 1, wherein the said electronic device (410) is a physical kiosk (510) located in a retail space.

11. A computer-based method allowing transactions in an augmented space on an electronic device according to claim 10, further comprising the option for the user to retrieve available products or services from said store at the time of purchase.

12. A computer-based method allowing transactions in an augmented space on an electronic device according to claim 11, wherein the said option for the user to retrieve available products or services from said store at the time of purchase includes a locker system whereby a purchased product or service is stored in a locked locker within or near to the store’s premises, and the unlock code for said locker is given to said user upon payment for the product or service.

13. A computer-based method allowing transactions in an augmented space on an electronic device according to claim 1, wherein the said interactable image includes said user performing various actions on the image that lead to a modified or new image being displayed.
